(19) United States
(12) Patent Application Publication
(10) Pub. No.: US 2010/0282354 A1
(43) Pub. Date: Nov. 11, 2010

(54) BRAKE HOSE

(75) Inventor: Daniel Polasky, (US)

Correspondence Address: RANKIN, HILL & CLARK LLP, 23755 LORAIN ROAD, SUITE 200, NORTH OLMSTED, OH, 44070, US

(73) Assignee: Electrovations, Inc.

(21) Appl. No.: 12/572,281

(22) Filed: Oct. 2, 2009

Related U.S. Application Data
(63) Continuation-in-part of application No. 12/435,505, filed on May 5, 2009, now abandoned.

(51) Int. Cl. F16L 11/04; F16L 11/02; B32B 37/14

(52) U.S. Cl. 138/126; 138/125; 156/149; 138/130

(57) ABSTRACT

An ultralow expansion brake hose comprising an inner tube, a reinforcement layer around the tube and including two oppositely wrapped served layers of PVA fibers encapsulated in a pliable adhesive and an outer layer of braided PVa fiber to stabilize the served layers.

This continuation in part application claims priority to and the benefit of the filing date of U.S. Continuation application Ser. No. 12/435,505, filed May 5, 2009, which application claims priority to and the benefit of the filing date of U.S. patent application Ser. No. 11/346,780 (abandoned) filed Feb. 3, 2006, which applications are incorporated herein by reference in their entireties.

The present invention relates to a small diameter flexible hose used in the brake system of an automobile and more particularly it relates to a brake hose having extremely low volumetric expansion, even at higher pressures, and the method of making this novel ultralow expansion brake hose.

### INCORPORATION BY REFERENCE

The technology to which the invention is directed is the subject of many prior patents revealing background and technical considerations in making a low expansion brake hose. To simplify the discussion of the background technology, several patents are incorporated by reference herein. They reveal the problems and prior endeavors in the field of the present invention. These patents are Suzuki U.S. Pat. No. 5,922,811; Horiba U.S. Pat. No. 6,220,304 Ishikawa U.S. Pat. No. 6,450,206; Bhattacharyya U.S. Pat. No. 6,623,822; Ono U.S. Pat. No. 6,695,015; and, Mizutani U.S. Pat. No. 6,736,167. The background technology of these patents is supplemented by U.S. publications 2005/0051227 and 2005/0121095. These 2005 publications are also incorporated by reference herein as background.

### BACKGROUND

The background technology of the several patent items incorporated by reference herein essentially modify the normal construction of a brake hose where two co-extensive braided layers are separated by an elastometric layer. In a few occasions, such as in Ono U.S. Pat. No. 6,695,015, the two braided layers are cured into a generally solid layer by a thermosetting resin. These prior attempts to provide a brake hose have failed to result in an ultralow volumetric expansion hose, such as an expansion less than 0.10 cc/ft for internal pressure of about 1500 psi or less than 0.20 cc/ft at a pressure of about 2500 psi. When trying to obtain such ultralow volumetric expansion, the resulting hose, in the past, had a very low whip life. Limitations of prior brake hoses in the area of expansion and whip life is well known in the automobile industry.

Automotive hydraulic brake system components must be designed to transmit the input of the operator to components of the system without loss of effectiveness. In the hydraulic brake system of an automobile, a brake hose is used to connect various components of the system. Consequently, a flexible connection is required. Expansion of the flexible hose during application of pressure in the hydraulic system reduces the effectiveness of the braking system. It is for this reason that designers of automobile braking systems seek a hose with a minimum of volumetric expansion. The result of this structural demand is the development recorded in many prior art patents, some of which form the disclosed background of the present invention. In addition to the volumetric expansion requirement of a brake hose, the brake hose is often connected between a movable component and a fixed component, it must, therefore, have a high flex durability. The hose used for the connection must operate reliably in a rapidly flexing environment to maintain the function of the brake system over a prolonged time. Standards have been established to measure volumetric expansion and durability or whip life of a brake hose. As shown in the background technology, when a flexible brake hose connection is required, the most popular design involves two braided layers over a flexible rubber tube. The hose consists of an inner rubber tube reinforced with two PVA fiber braid layers separated by a solid elastometric layer. This is shown in many prior art patents, such as Suzuki U.S. Pat. No. 5,922,811. Two braids separated by an elastometric layer are often covered with a suitable flexible jacket, which is typically rubber. This common construction has acceptable volumetric expansion characteristics for most less critical applications and has a long term durability in a system requiring flexing. However, certain more critical applications require lower volumetric expansion performance than is available with the traditional brake hose including two braided layers. For these high performance applications, hose manufacturers have developed a hose with a PTFE inner tube encircled by a single stainless steel braid. This construction often includes an outer jacket of clear polymetric material, such as PVC. This ultralow volumetric expansion type of brake hose is able to obtain volumetric expansion levels of approximately 50% of the traditional hose including two braided layers. However, this hose is prone to fatigue failure with flexing due to the nature of the stainless steel braiding. Furthermore, the PTFE/stainless braid construction is significantly more costly than the two PVA braided construction. For this reason the traditional design has met with the most commercial acceptability. Consequently, the background of the present invention involves a somewhat standard brake hose and a modification of the brake hose to drastically reduce volumetric expansion by using stainless steel.

### THE INVENTION

The invention involves an ultralow volumetric expansion brake hose having high durability. The invention involves an inner tube that has been re-enforced with double wrapped served layers of PVA fibers overlaid by a braided reinforcement PVA layer. The volumetric expansion characteristic for this new construction is about 44% to 53% lower than the prior art brake hose having two braided layers of PVA fibers. This new hose has been shown in testing to have equivalent volumetric expansion compared to PTFE/stainless braided hose. The new hose meets the hose whip test requirement per SAE J1401. Furthermore, the cost of manufacturing this hose is substantially less than the prior commercial effort to obtain an ultralow volumetric expansion for a brake hose.

In accordance with the present invention there is provided an ultralow expansion brake hose comprising an inner tube and a novel reinforcement structure or layer surrounding the inner tube. This novel reinforcement layer includes two oppositely wrapped served layers of PVA fibers encapsulated in and penetrated by a pliable adhesive. A braided outer layer of PVA fiber is applied over the served layers to stabilize the reinforcement layer. By employing a pliable and penetrating adhesive for both the two served layers and under the stabilizing layer, the fibers of these layers can assume their desired shape without friction action between the individual strands of the oppositely wrapped layers or the encircling stabilizing layer. The oppositely wrapped served layers have a lay angle of about 55-56° so that the layers are essentially positionally stabilized and held in their respective pressure absorbing positions by the stabilizing outer braid layer. In accordance with the commercial version of the novel hose, a highly flexible outer extruded cross linked silicone rubber jacket covers the stabilizing braid layer to prevent contamination of the adhesive holding the various layers together as well as providing a pleasing appearance. The pliable adhesive encapsulating the served layers and stabilizing braid layer is air cured and is selected from the class consisting of polychoropene rubber. The inner tube is a cross linked plastic, such as cross linked type 6 nylon. In all instances the inner tube is flexible and strengthened to resist rupture by high pressure within the tube. The fibers of the two wrapped served layers is preferably vinylon. The outer plastic jacket in the preferred embodiment of the invention is silicone rubber cured by heat after being applied around the stabilizing braid layer. The wrap length of the opposite wrapped served layers is about 0.4 to 0.6 inches.

In summary, the invention is an ultralow expansion brake hose comprising a flexible inner tube surrounded by two served layers of oppositely wrapped fibers, wherein the served layers are stabilized by a surrounding braid layer of fiber. An adhesive penetrates and encapsulates the fibers into a pliable matrix so the various fibers can perform their strength function and holding force function individually by the allowed movement of the pliable matrix.

In accordance with another aspect of the invention there is provided a method of making an ultralow expansion brake hose, which method comprises: providing a flexible inner tube formed from cross linked plastic, coating the tube with an air set adhesive, wrapping a first served fiber layer onto the coated tube with a first wrapped direction, wrapping a second served fiber layer onto the first layer where the second served layer has an opposite wrap direction. The served layers are coated with an adhesive to form a matrix capturing the served layers. A stabilizing layer is braided onto the served layers before at least the second coated adhesive layer is air set. Then, the adhesive layer or layers are set into a pliable matrix.

A brake tube constructed in accordance with the present invention has an ultralow volumetric expansion. At 1000 psi, the expansion is about 0.06 cc/ft. This low volumetric expansion is obtained without reducing the durability as tested by a “whip” test where the hose constructed in accordance with the present invention had a whip life greater than about 200 hours. In the past, a hose having low volumetric expansion approaching, but not reaching, the level of the present invention had a whip life substantially less than about 5-10 hours. Consequently, the present invention involves an ultralow volumetric expansion hose with a high durability. This is the primary object of the present invention.

Another object of the present invention is the provision of a hose, as defined above, which hose allows movement between the served layers and stabilizing braid layer with the wrap angles of the served layers maintaining control over the expansion of the hose.

Another object of the present invention is the provision of an ultralow expansion tube as defined above, and the method producing this tube to provide two oppositely wrapped served layers stabilized by a braid layer.

Yet another object of the present invention is the provision of a hose and method, as defined by the appended claims of this application.

These and other objects and advantages will become apparent from the following description taken together with the accompanying drawings.

### BRIEF DESCRIPTION OF DRAWINGS

FIG. 1 is a perspective, cross-sectional view of the preferred embodiment of the present invention;

FIG. 2 is a side elevational view illustrating schematically equipment for processing the novel hose between an incoming flexible inner tube and two oppositely wrapped served layers encapsulated by a rubbery adhesive;

FIG. 3 is an enlarged partial cross-sectional view taken generally along line 3-3 of FIG. 2;

FIG. 4 is an enlarged partial cross-sectional view taken generally along line 4-4 of FIG. 2;

FIG. 5 is a side elevational view showing schematically equipment for processing the novel tube between the last stage of FIG. 2 and the final braid over the two oppositely wrapped served layers;

FIG. 6 is an enlarged partial cross-sectional view taken generally along line 6-6 of FIG. 5;

FIG. 7 is an enlarged partial cross-sectional view taken generally along line 7-7 of FIG. 5;

FIG. 8 is a side elevational view illustrating schematically the remaining equipment used for processing the hose after it leaves the equipment of FIG. 5; and,

FIG. 9 is an enlarged partial cross-sectional view taken generally along line 9-9 of FIG. 8.

### DESCRIPTION OF THE INVENTION

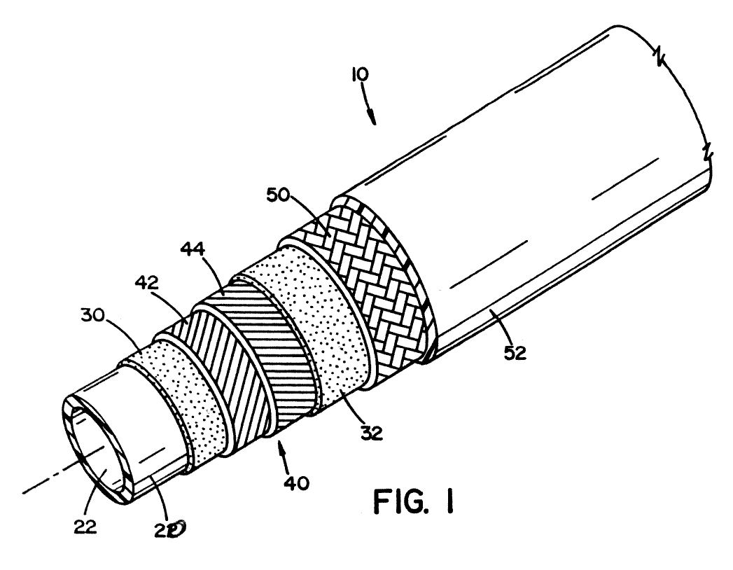

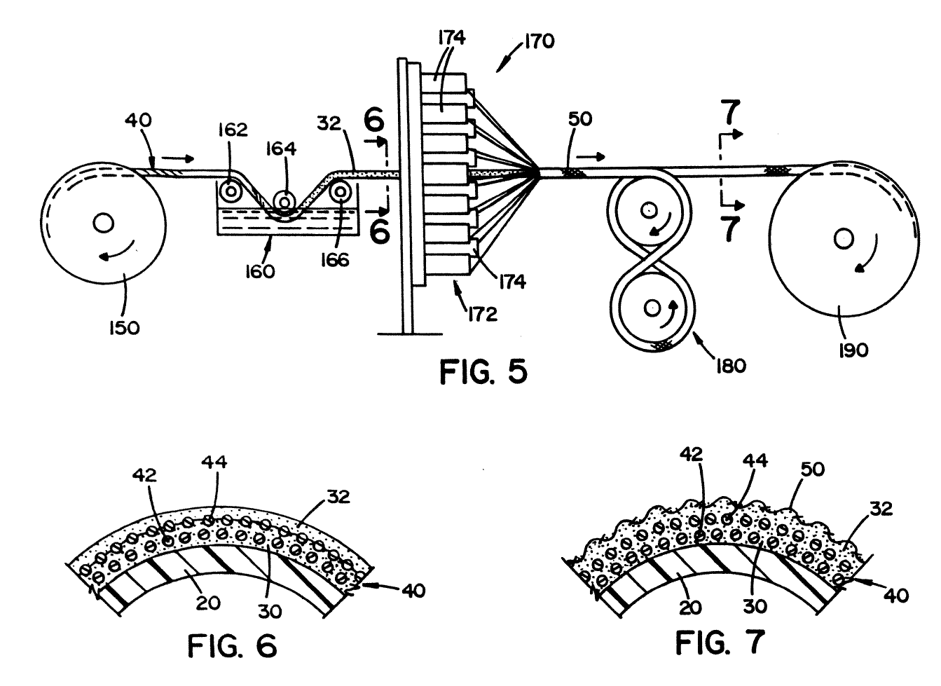

Referring now to the drawing wherein the showings are for the purpose of illustrating a preferred embodiment of the invention only and not for the purpose of limiting same, FIG. 1 shows a novel ultralow volumetric expansion brake tube 10 having an inner tube or core 20 with a central passageway 22. This core is preferably a cross link nylon 6, such as ETG-61 sold by Mercury Plastics. The cross linked nylon core is a type 6 nylon that is hydroscopic. The core is dried to remove most of the moisture by heating the core tube for 24 hrs. at 280° F. Around this inner dried core tube 20 is a coated adhesive layer 30 which is air cured to a rubbery, pliable consistency. This rubbery mass is cured after it receives subsequent layers and is preferably formed from chloroprene adhesive. Adhesive layer 30 in its uncured state receives the novel reinforcement layer 40 comprising a first layer 42 and a second layer 44. Layers 42, 44 are wrapped in opposite directions and are isolated by the rubbery matrix 30 that oozes through the interstices of the two layers and significantly penetrates the fibers as they are wound onto tube 20 and sink into adhesive layer 30. Serve or served layers 42, 44 are PVA fibers with a pitch geometry known to the hose industry to maximize burst performance. The lay angle is in the range of 55°-56° with a pitch length of 0.40-0.60 inches. Reinforcement layer 40 is saturated and bonded with the adhesive 30 applied to the surface of core 20 prior to the wrapping or serving of layers 42, 44 onto the tube 20. The chloroprene adhesive 30 is a moisture barrier and is provided as a single extrusion over the inner tube or core 20. The second served layer 44 provides a more concentrated reinforcement of the total layer 40. Because the fibers within two layers 42, 44 are straightened and in parallel relationship to the other fibers within the layer, they are able to take the load created by the expanding core as pressure is applied without assuming a less wavy configuration. Thus, the volumetric expansion is reduced in the novel hose 10 using the two served layers 42, 44. The layers have a pitch length of about 0.4 to 0.6 inches and a pitch angle of about 55°, 55″. The fibers in the two layers 42, 44 are essentially at the technically proper position to withstand volumetric expansion. The two layers are saturated and the individual fibers penetrated and bonded so there are no spaces within the reinforcing layers. This further contributes to the improved volumetric expansion characteristics of hose 10. One feature of the invention does not employ an intermediate layer, as is normally used in prior art constructions. This lack of an intermediate layer between the two oppositely wrapped served layers allows the finished diameter of hose 10 to be somewhat smaller. This also allows the outer braid layer 50 to be smaller and provide the required burst performance with less fibers. After layers 42, 44 are wrapped around tube 20 and sink into adhesive 30, a second adhesive coating 32 is applied over the two served layers. This layer then encapsulates the two served layers 42, 44 so that the layers are dispersed in a rubbery mass or matrix, as best shown in FIGS. 6, 7 and 9. The second adhesive coating is formed from the same material as adhesive coating 30 and forms an outer mass. Layers 42, 44 are encapsulated in the adhesive mass before the air cured adhesive has set. Braid layer 50 is the second reinforcing layer to stabilize the novel internal layer 40. This braid consists of 24 packages, each of 2 ends of 1200 denier PVA. These two braided patterns are formed by a standard braiding machine as shown in FIG. 5 with the braid geometry set to maximize hose performance. The stability of the first two served layers 42, 44 is increased by braid layer 50. The two served layers 42, 44 rely on bonding between the layers to hold their relative positions. With the outer braid 50, the total construction is less susceptible to bond failure to thereby enhance the reliability of the hose construction. The braid layer is applied over the two serve layers that have just been embedded in adhesive 30. The adhesive of layers 30, 32 is air cured into a rubbery mass to improve the flex life performance. This adhesive serves as a barrier to moisture from atmospheric conditions. Braid layer 50 is applied around adhesive layer 32 to encapsulate layers 42, 44 and embed the braid. Thus, three fiber layers are captured in the matrix as best shown in FIGS. 7 and 9. When the adhesive is finally air cured, the three layers are within the same matrix to control the action between the layers in preventing expansion of hose 10 when high pressure is passed through opening 22. This structure includes the basic novel structure of hose 10; however, such hose requires a decorative coating or jacket. In the present invention, jacket 52 forms another function and includes a high strength silicone material pressure extruded over the braid layer 50. The braid is treated with a primer and a silicone adhesive to establish a bond between the braid and the jacket. In the preferred embodiment of the invention, jacket 52 is formed from a high strength silicone rubber; however, the jacket could be EPDM, nylon, urethane, thermoplastic polyester, polypropylene, PVC, or other materials known to make a good hose jacket. When using the high strength silicone rubber as a jacket, the completed hose is post cured at 220° to 250° F. to improve the bond to the braid layer.

Following the application of the hose jacket, the completed hose is filled with water for a time long enough to fully moisturize the type 6 nylon. This is done for two reasons.
1 Type 6 nylon that has not been moisturized is brittle and performs poorly in the required hose whip test.
2. Volumetric expansion is significantly affected. It has been found unexpectedly that constructing the hose with a dried type 6 nylon core and then introducing the proper level of moisture back into the core tube improves volumetric expansion to a significant amount. It is believed that the core swells slightly as moisture is reintroduced and pretensions the reinforcement reducing volumetric expansion.

After the core has come to the proper moisture level, the water is removed from the hose with compressed air.

Hose 10 has been “whip” tested with several jacket materials and with a completely unjacketed structure. The particular samples jacketed with high strength silicone rubber have far exceeded the performance of an unjacketed hose and a PVC jacketed hose. The temperature of the flexed portion was lower than the temperature of the same section of other samples when measured with an IR temperature sensor. Thus, in the preferred embodiment of the invention a silicone rubber jacket 52 is used with the result that it increases the durability of brake hose 10.

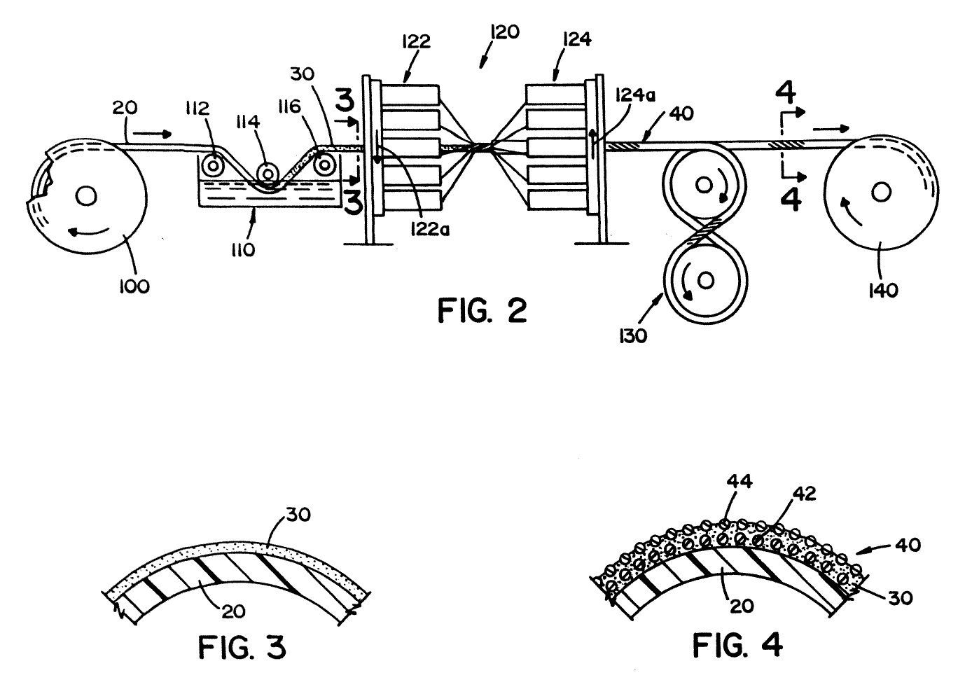

Hose 10 is constructed using standard coating and/or weaving equipment. In the preferred embodiment, equipment illustrated in FIGS. 2, 5 and 8, taken together produce the novel hose as described. Turning now to FIG. 2, reel 100 has a supply of purchased tube 20 formed of cross linked nylon available from Mercury Plastics and provided in a large supply reel. The core is dried to remove the moisture normally present in type 6 nylon prior to applying reinforcement. This reel feeds the serving operation by directing tube 20 through bath 110 of adhesive 30 for application of air set adhesive 30 as it is directed by guide rolls 112, 114 and 116. After adhesive bath 110, the coated tube, as shown in FIG. 3, is pulled through a wrapping station 120 having two wrapping heads or decks 122, 124 rotated in the direction of arrows 122a, 124a, respectively and manually converted at the guide ring to provide wrap layers 42, 44 in succession over the uncured adhesive, as shown in FIG. 4. The wrapping station 120 includes two wrapping heads consisting of twelve packages each at two ends of 1200 denier PVA fiber. The two wrap layers are bonded together by the adhesive 30 to produce two served layers 42, 44. Capstan 130 holds the tube with a force to maintain precise control of the wrap geometry as the layers are applied to the tube by converted weaving machines 122, 124. Inner core 20 with encapsulated layers 42, 44 is then wrapped onto reel 140 after the tube has the construction as shown in FIG. 4. Two served layers are embedded into uncured adhesive 30. The material on reel 140 is converted to a braiding supply reel 150, as shown in FIG. 5. The hose, having the construction shown in FIG. 4, is pulled through bath 160 containing the same adhesive as coating 30. This second coating of air set adhesive is applied over the top of layer 44 and is commingled with the adhesive of layer 30. After application bath 160, the tube has the construction shown in FIG. 6 and is pulled through a braiding station 170 consisting of a 24 package, each of two ends of 1200 denier PVA fiber applied by braiding device 172. The fibers are each stored on spools 174 for weaving onto tube 20. Capstan 180 maintains precise control of the braid geometry as the hose is pulled through braiding device 172 of station 170. Thereafter, braid 50 encapsulates over the top of the two layers of adhesive to encapsulate the braid and layers 42, 44, as best shown in FIG. 7. This essentially finishes the tube which is wrapped on supply reel 190 for further use or subsequent processing. The hose remains on reel 190 until layers 30, 32 are commingled and provide a matrix for the three layers of fiber. Thereafter, the adhesive is air cured or air set into a rubbery matrix or mass. The hose is now completed and can be used; however, it has been found that a more durable brake hose is provided by the unique outer jacket 52 which also adds to the aesthetic value of the finished hose.

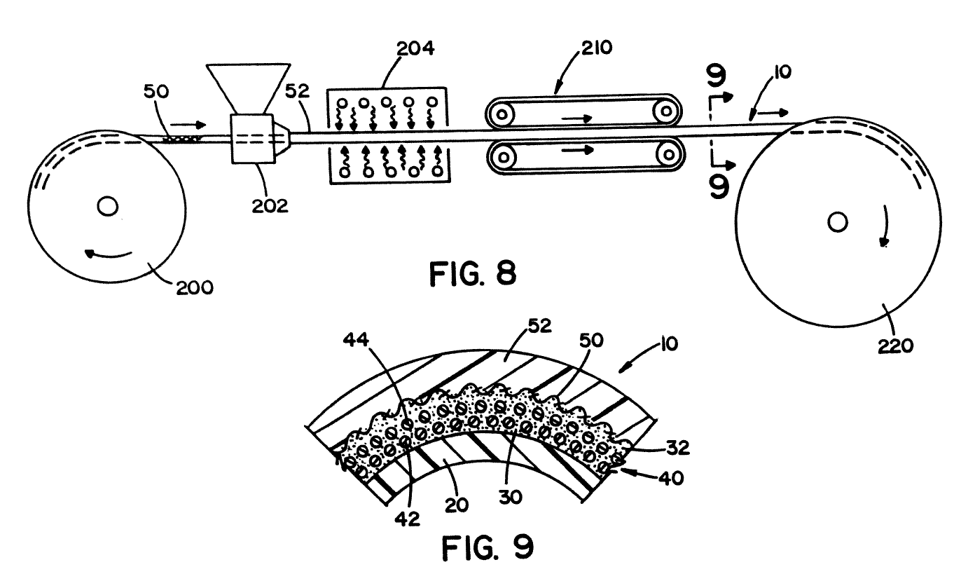

Flexible jacket 52 is provided over the hose construction as shown in FIG. 7 by using the final equipment schematically illustrated in FIG. 8. In FIG. 8, supply reel 200 of a hose having a structure shown in FIG. 7 is directed to extruder 202 for extruding a layer 52 of silicone rubber. This rubber is cross linked by continuous oven 204 for thermosetting of the rubber into a fixed pliable mass over the structure. This final product is illustrated in FIG. 9. Belt pulling device 210 maintains precise control of the extruded jacket or layer 52 as it is applied to the braided product by extruder 202. The completed hose is post cured at 220° to 250° F. to improve the bond to the braid layer. Following post cure, the completed hose is filled with water for a time long enough to fully moisturize the type 6 nylon. After the core has come to the proper moisture level, the water is removed from the hose with compressed air. The final hose is then stored on supply reel 220 for subsequent shipment to customers.

The basic concept of the present invention is the provision of the encapsulated oppositely wrapped served layers 42, 44 stabilized by an outer braided layer 50. Several variations in hose 10 have been described; however, the following is one example of the present invention.

### Example

In the representative example, inner tube 20 has an internal diameter of 0.150″ with a tube wall of 0.30″ and is produced using ETG-61 as cross linked type 6 nylon material. This tube is purchased from Mercury Plastics of Middlefield, Ohio. The tube material is electron beam cross linked. The core is dried to remove the moisture normally present in type 6 nylon prior to applying reinforcement. The inner tube is run through a bath of polychloroprene. Applied over the inner tube are two layers of 12 two end groups of 1200 denier PVA fiber. These two reinforcement layers are applied as two wraps in opposite directions with a yarn pitch of 0.48 inches of lay length or pitch length for this size. The inner diameter is reduced to a nominal 0.130″ ID by the first pass reinforcing operation. The outside diameter of this wrapper or served layer 44 is 250″ outside diameter.

The wrapped or served inner tube is then passed through a bath of polychloroprene which penetrates between the fiber ends and within the fiber filaments. The wrapped or served inner tube that passes through the bath is then braided with 24 packages of PVA fiber consisting of two ends of 1200 denier PVA fiber. The fiber is applied at a 0.57 inch pitch length for this size. The outside diameter of the second braid in this example is 0.294″ outside diameter.

The inner tube with the first wrapped or served layer and the second braid layer is coated with an outer layer or jacket of high strength silicone rubber. In this example a primer and a silicone adhesive was applied to the braid to aid the bond of the silicone rubber to the PVA braid material. The completed hose with the high strength silicone rubber applied is passed through a heat source to cross link the silicone rubber. The completed hose is post cured at 220° to 250° F. to improve the bond to the braid layer. Following post cure, the completed hose is filled with water for a time long enough to fully moisturize the type 6 nylon. After the core has come to the proper moisture level, the water is removed from the hose with compressed air.

The example hose has a volumetric expansion 50% of the conventional GY5052 hose and a volumetric expansion equal to or better than Teflon hose with a stainless steel braid. The whip life of the example hose is in excess of 200 hours. The whip hose life of Teflon hose with a stainless braid in the same test configuration is about two hours.

1. An ultralow expansion brake hose for directing a fluid flow, said brake hose comprising a central passage which at least partially directs an associated fluid flow and extending radially outwardly from said central passage to an outer surface, said hose consisting of only an inner tube layer, a reinforced layer, a braided layer and an outer jacket layer, said inner tube layer having a radially inwardly facing surface coaxial with a passage axis and a radially outwardly facing extent, said inward facing surface forming said central passage, said reinforced layer including an adhesive structure layer surrounding and penetrating only a first fibers layer and a second fiber layer, said first fiber layer being wrapped in a first direction about said axis and said second fiber layer being wrapped in a second direction about said axis, said second direction being the opposite of said first direction, said braided layer being formed by a single layer of braided fibers, said outer jacket encapsulating said braided layer and having said outer surface.

2. A brake hose as defined in claim 1 wherein the lay angle of said a first and second fibers layers is in the range of about 55° to 56°.

3. A brake hose as defined in claim 1 wherein said adhesive structure layer is formed by a pliable adhesive.

4. A brake hose as defined in claim 3 wherein said pliable adhesive is an air cured plastic.

5. A brake hose as defined in claim 1 wherein said adhesive structure layer is formed by a pliable and penetrating adhesive.

6. A brake hose as defined in claim 1 wherein said inner tube is a cross linked nylon tube.

7. A brake hose as defined in claim 6 wherein said inner tube is a tube of cross linked type 6 nylon that has been dried to remove a substantial amount of moisture.

8. A brake hose as defined in claim 1 wherein said inner tube that has been dried to remove a substantial amount of moisture.

9. A brake tube as defined in claim 1 wherein said first and second fibers layers are formed by vinylon fibers.

10. A brake tube as defined in claim 1 wherein said outer jacket layer is a cured silicone rubber.

11. A brake tube as defined in claim 1 wherein said first and second fibers layers each have a pitch length and said pitch length is about 0.4 to 0.6 inches.

12. A brake hose as defined in claim 11 wherein the lay angle of said a first and second fibers layers is in the range of about 55° to 56°.

13. A brake hose as defined in claim 1 wherein said brake hose has a volumetric expansion and said volumetric expansion is less than 0.07 cc/ft at 1000 psi.

14. An ultralow expansion brake hose for directing a fluid flow, said brake hose comprising a central passage which at least partially directs an associated fluid flow and extending radially outwardly from said central passage to an outer surface, said hose having an inner tube layer with a radially inwardly facing surface coaxial with a passage axis and a radially outwardly facing extent, said inward facing surface forming said central passage, said hose further including a first adhesive layer surrounding said outward extent of said tube layer, a first reinforcement fiber layer embedded in said first adhesive layer, said first reinforcement layer being formed by fibers wrapped in a first direction about said axis, a second reinforcement fiber layer positioned over top of said first reinforcement layer, said second reinforcement layer being formed by fibers wrapped in a second direction about said axis and said second direction being the opposite of said first direction, a second adhesive layer over said second reinforcement fiber layer, said first and second adhesive layers at least partially commingling thereby producing an adhesive structure substantially encapsulated and penetrated said first and second fiber layers, said hose further included an outer braided fiber layer over said adhesive structure, said braided layer stabilizing said first and second fiber layers, said hose further including an outer jacket encapsulating said braided layer, said outer jacket having said outer surface.

15. A brake hose as defined in claim 14 wherein said first and second fiber reinforcement layers are separated from one by said adhesive structure.

16. A brake hose as defined in claim 15 wherein said first and second adhesive layers are formed by the same adhesive.

17. A brake hose as defined in claim 14 wherein said first and second fiber reinforcement layers are encapsulated in and penetrated by said adhesive structure.

18. A brake hose as defined in claim 14 wherein said brake hose has a volumetric expansion and said volumetric expansion is less than 0.07 cc/ft at 1000 psi.

19. A method of making an ultralow expansion brake hose, said method comprising:
(a) providing a flexible inner tube;
(b) removing moisture from said tube;
(c) coating said tube with an adhesive layer forming a coated tube;
(d) wrapping a first fiber layer onto said coated tube with a first wrap direction before said adhesive layer sets;
(e) wrapping a second fiber layer onto said first layer where said second served layer has an opposite wrap direction;
(f) coating said first and second fiber layers with a second adhesive layer to form a matrix capturing said first and second fiber layers;
(g) braiding a stabilizing layer over said first and second fiber layers and directly on said second adhesive layer before said second adhesive layer sets; and,
(h) applying a highly flexible outer extruded plastic jacket directly to said stabilizing layer.

20. A method as defined in claim 19 further including moisturizing said flexible inner tube after said applying step.

21. A method as defined in claim 20 wherein said moisturizing step includes filling said flexible inner tube with water.

22. A method as defined in claim 19 wherein said flexible inner tube is a cross linked type 6 nylon.

23. A method as defined in claim 19 wherein said removing step is a drying step to substantially reduce said moisture is said inner tube.

24. A method of making an ultralow expansion brake hose, said method comprising:
(a) providing a flexible inner tube;
(b) removing moisture from said tube;
(c) layering material over said tube to reduce volumetric expansion of said brake hose; and,
(d) moisturizing said flexible inner tube after said layering step.
